(19) United States
(12) Patent Application Publication
(10) Pub. No.: US 2009/0193955 A1
(43) Pub. Date: Aug. 6, 2009

(54) Crush Cutter Arrangement Having An Exchange Aid For The Crush Cutter

(76) Inventor: Rudolf Supe-Dienes, Overath (DE)

Correspondence Address: ROBERT W. BECKER & ASSOCIATES, 707 HIGHWAY 333, SUITE B, TIJERAS, NM, 87059-7507, US

(21) Appl. No.: 12/363,241

(22) Filed: Jan. 30, 2009

(30) Foreign Application Priority Data
Feb. 2, 2008 (DE) 20 2008 001 485.9

(51) Int. Cl. B26D 7/26; B26D 5/08

(52) U.S. Cl. 83/698.11; 83/639.1; 83/698.41

(57) ABSTRACT

A cutter arrangement including a crush cutter holder with a pneumatically actuatable piston and a fork-shaped blade holder supported thereby. A crush cutter is disposed in a positively engaging manner between the arms of the fork. For exchange purposes, the crush cutter can be displaced and moved out of the fork. A lower blade is associated with the crush cutter. A lever is disposed on the housing of the crush cutter holder so as to be pivotable about a bearing point. The lever is pivotable out of a release position for the crush cutter into a first contact position against the outer periphery of the crush cutter, and furthermore into a displacement position for the crush cutter leading to release of the crush cutter from the fork.

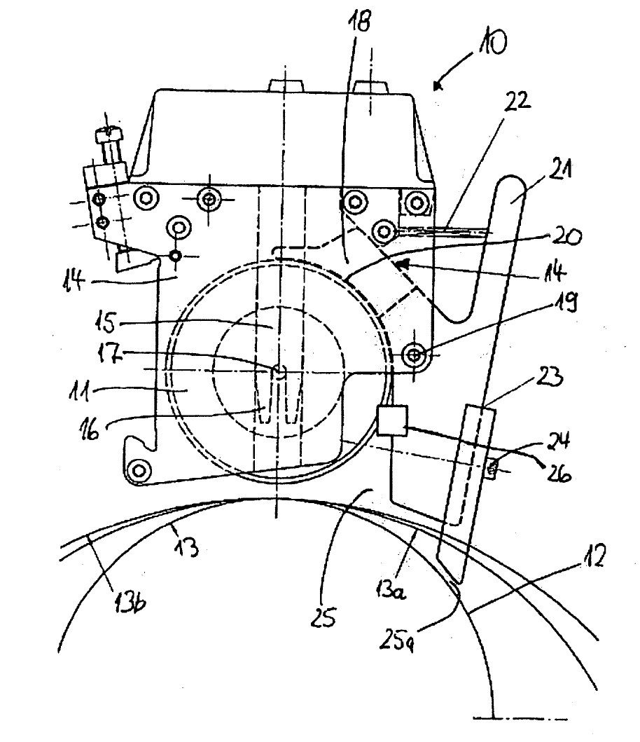

The instant application should be granted the priority date of Feb. 2, 2008 the filing date of the corresponding German patent application 20 2008 001 485.9.

### BACKGROUND OF THE INVENTION

The present invention relates to a crush cutter arrangement having a crush cutter holder that includes a pneumatically actuatable piston and supports thereon a blade holder in the form of a fork. The crush cutter is disposed in a positively engaging manner between the arms of the fork, and for exchange purposes can be displaced and moved out of the fork. A lower blade is associated with the crush cutter.

A crush cutter holder used in the context of such a crush cutter arrangement and corresponding to the aforementioned features is known from DE 37 26 143 A1. A shaft or arbor of the crush cutter is mounted in a form-fitting, positively engaging or frictional manner between the arms of a fork-shaped blade holder, so that for replacement purposes it is merely necessary to displace the crush cutter and press it out of the arms of the fork.

It is an object of the present invention, for a crush cutter holder of the aforementioned general type, to facilitate the exchange or replacement of the crush cutter and to accelerate such a procedure.

### BRIEF DESCRIPTION OF THE DRAWING

This object, and other objects and advantages of the present invention, will appear more clearly from the following specification in conjunction with the sole FIGURE of the drawing, which shows one exemplary embodiment of the invention and is a side view of a crush cutter holder and the associated lower blade.

### SUMMARY OF THE INVENTION

The basic concept of the present invention is that a lever is disposed on the housing of the crush cutter holder in such a way as to be pivotable about a bearing point, wherein the lever is pivotable out of a release position for the crush cutter into a first contact position against the outer periphery of the crush cutter, and furthermore into a displacement position for the crush cutter leading to release of the crush cutter from the fork.

The arrangement of the present invention has the advantage that for the exchange or replacement of the cutter or blade, it is merely necessary to pivot the lever out of its release position to such an extent that the crush cutter, along with its bearing support, comes free from the fork-shaped blade holder, so that a new crush cutter can be pressed into the blade holder.

Pursuant to one specific embodiment of the present invention, it is advantageous for the lever to be biased into its release position by means of a spring that is supported on the housing of the crush cutter to holder, whereby the spring biasing is to be overcome with the rotation or pivoting of the handle for the replacement of the crush cutter. However, due to the spring action, the lever is held out of engagement with the periphery of the crush cutter.

Pursuant to one embodiment of the invention, the lever can be provided with a handle, which serves for carrying out the pivoting movement of the lever.

Alternatively, the lever can be pivoted by means of a tool that is to be applied separately.

Pursuant to a particularly advantageous embodiment of the invention, the lever is assigned a further function by providing the lever in such a way with an extension, which projects toward the lower blade that is associated with the crush cutter, and which is laterally offset relative to the cutting zone, that in the release position of the lever the feed-in gap, for the material that is to be cut, and which exists between the rotating crush cutter and the rotating lower blade, is at least partially covered. In this way, the work safety rules can be taken into consideration, which prescribe that the feed-in gap between two rotating parts, in other words in the present case between the crush cutter and the lower blade, may not exceed an amount of, for example, 4 mm. By means of the dual function assigned to the lever, it is possible by means of the extension provided on the lever to reduce the dimension of the feed-in gap to a harmless amount of, for example, less than 4 mm. In this connection, with a lower blade that is stationarily assigned to the crush cutter, a fixed arrangement of the extension on the lever is sufficient.

However, since a crush cutter of the aforementioned general type can be used with lower blades having different radii, pursuant to another embodiment of the invention the extension can be adjustably disposed on the lever to enable an adaptation of the position of the lever to various radii of lower blades, so that by means of the adaptation of the position of the extension on the lever, the feed-in gap can be covered in a necessary manner depending upon the radii realized at the lower blade.

Pursuant to one embodiment of the invention, the inventive lever can be designed for the support of a functional or operating element, which in the release position of the lever, i.e. essentially in the cutting position of the crush cutter, rests against the blade edge of the crush cutter. Pursuant to further embodiments of the invention, such an operating element can be a cleaning felt in order, during the cutting operation, to be able to eliminate cut material that adheres to the crush cutter; alternatively, the operating element can be an oiler, in order to oil the blade edge and thereby possibly also to clean. Further functions of the operating element are also included thereby.

Further specific features of the present application will be described in detail subsequently.

### Description of Specific Embodiments

Referring now to the drawing in detail, illustrated is a crush cutter holder 10 having a crush cutter or blade 11 disposed thereon, as well as a lower blade 12 that is associated with the crush cutter 11. The circumferential line of the lower blade 12 is designated by the reference numeral 13, and the reference numerals 13a and 13b illustrate imaginary circumferential lines for other lower blades that respectively have different radii.

A fork-shaped blade holder is disposed in the housing 14 of the crush cutter holder 10, the function of which is described in the aforementioned DE 37 26 143 A1, wherein further explanation thereof can be derived from that document. The crush cutter 11, with support extensions 17 formed thereon, is held between the arms 16 of the fork 15, and in particular in a form-fitting, positively engaging, or frictional connection therewith.

A lever 18 is mounted on the housing 14 so as to be pivotable about a bearing point 19. On that side that faces the crush cutter 11, to the lever 18 is provided with an abutment surface 20 that is adapted to the blade periphery. In the illustrated embodiment, to be able to manipulate the lever 18 the lever is provided with a handle 21 that extends away from the housing 14. In the illustrated release position of the lever 18 for the crush cutter 11, in which the abutment surface 20 of the lever 18 does not prevent a rotation of the crush cutter 11, the lever 18 is biased by a compression spring 22 that is supported between the housing 14 and the handle 21, so that the lever 18 is respectively pivotable against the spring effect of the spring 22 in the direction of the crush cutter 11. Furthermore, an extension 23, which in the illustrated embodiment is displaceable, is disposed on that end of the lever 18 that faces the lower blade 12; this displaceable extension 23 can be fixed in position by means of a set screw 14. If a feed-in gap 25 for the material that is to be cut (not illustrated) exists between the crush cutter 11, which rotates for example in a clockwise direction, and the lower blade 12, which correspondingly rotates in a counter clockwise direction, the extension 23 disposed on the lever 18 serves to reduce this feed-in gap to an effective feed-in gap 25a, which corresponds to work safety rules and during operation of the cutting arrangement in questions represents no danger for possible operating personnel.

In a further function, the lever 18 also serves for the support of an operating element 26, which pursuant to exemplary embodiments can, for example, be embodied as cleaning felt or as an oiler for the blade edge. In this connection, the operating element 26 is mounted on the lever 18 in such a way that in the release position of the lever 18 that can be seen from the drawing, the operating element rests against the blade edge of the crush cutter 11. The operating element 26 is in particular mounted in such a way that the contact of the crush cutter 11 with the operating element intensifies during the lowering of the crush cutter 11 relative to the lever 18 that is secured to the housing 14.

To carry out a replacement or exchange of the crush cutter 11 in the crush cutter holder 10 it is merely necessary to pivot the lever 18 in a counter clockwise direction toward the crush cutter 11 against the effect of the spring 22, whereupon after “over pressing” the contact of the abutment surface 20 of the lever 18 against the outer periphery of the crush cutter 11, the crush cutter, along with its support extensions 17, is pressed out of the fork 15, which forms the blade holder, and hence can be removed form the crush cutter holder 10. As a consequence of the pivoting of the lever 18, at the same time the operating element 26 is brought out of engagement with the crush cutter 11, so that the operating element 26 does not disrupt the cutter or blade exchange. After releasing the lever 18, it returns, under the effect of the spring 22, into its release position illustrated in the drawing, so that a new crush cutter 11 can be inserted between the arms 16 of the fork 15.

The features of the subject matter of these documents disclosed in the preceding specification, the claims and drawing can be important individually as well as in any combination with one another for realizing the various embodiments of the invention.

The specification incorporates by reference the disclosure of German priority document 20 2008 001 485.9 filed Feb. 2, 2008.

The present invention is, of course, in no way restricted to the specific disclosure of the specification and drawing, but also encompasses any modifications within the scope of the appended claims.

What I claim is:

1. A crush cutter arrangement, comprising:
a crush cutter holder having a housing, wherein said crush cutter holder supports a blade holder in the form a fork having arms;
a crush cutter disposed in a positively engaging manner between said arms of said fork, wherein for exchange purposes said crush cutter is adapted to be displaced and moved out of said fork;
a lower blade associated with said crush cutter; and
a lever disposed on said housing of said crush cutter holder in such a way as to be pivotable about a bearing point, wherein said lever is pivotable out of a release position for said crush cutter into a first contact position against an outer periphery of said crush cutter, and furthermore into a displacement position for said crush cutter leading to release of said crush cutter from said fork.

2. A crush cutter arrangement according to claim 1, wherein a spring is supported on said housing of said crush cutter holder, and wherein said lever is biased into said release position by means of said spring.

3. A crush cutter arrangement according to claim 2, wherein said lever is provided with a handle that serves for carrying out a pivoting movement of said lever.

4. A crush cutter arrangement according to claim 2, wherein said lever is adapted to be pivoted by means of a tool that is to be applied separately.

5. A crush cutter arrangement according to claim 2, wherein said lever is provided with an extension that projects in a direction toward said lower blade and that is offset laterally relative to a cutting zone, and wherein in said release position of said lever said extension at least partially covers a feed-in gap for material that is to be cut that exists between a rotating crush cutter and a rotating lower blade.

6. A crush cutter arrangement according to claim 5, wherein said extension is adjustably disposed on said lever to enable an adaptation of a position of said lever to various radii of lower blades.

7. A crush cutter arrangement according to claim 2, wherein an operating element is supported on said lever, and wherein in said release position of said lever said operating element rests against a blade edge of said crush cutter.

8. A crush cutter arrangement according to claim 7, wherein said operating element is embodied as a cleaning felt.

9. A crush cutter arrangement according to claim 7, wherein said operating element is embodied as an oiler.
